(19) United States
(12) Patent Application Publication
(10) Pub. No.: US 2026/0238036 A1
(43) Pub. Date: Aug. 13, 2026

(54) UNINTERRUPTIBLE POWER SUPPLY FOR HVAC&R SYSTEM

(71) Applicant: Tyco Fire & Security GmbH, Neuhausen am Rheinfall (CH)

(72) Inventors: Bryson Lee Sheaffer, Mechanicsburg, PA (US); Jordan Quinn Steiner, York, PA (US); Sarah E. Hamilton, New Freedom, PA (US); Paul William Snell, York, PA (US)

(21) Appl. No.: 19/154,260

(22) PCT Filed: Feb. 7, 2024
(86) PCT No.: PCT/US2024/014801

§ 371 Date: Aug. 6, 2025

Related U.S. Application Data
(60) Provisional application No. 63/443,921, filed on Feb. 7, 2023.
(60) Provisional application No. 63/460,236, filed on Apr. 18, 2023.

(51) Int. Cl. H02J 9/06; F04D 17/10; F04D 25/06; F25B 31/00

(52) U.S. Cl. CPC H02J 9/06; F04D 17/10; F04D 25/0673; F25B 31/004; F25B 2500/16

(57) ABSTRACT

A heating, ventilation, air conditioning, and/or refrigeration (HVAC&R) system includes a compressor having a bearing. The HVAC&R system also includes a pump configured to supply a flow of pressurized fluid to the bearing. Additionally, the HVAC&R system includes a main power supply configured to supply power to the pump. Furthermore, the HVAC&R system includes an uninterruptible power supply configured to supply power to the pump in response to an interruption in supply of power to the pump via the main power supply.

### CROSS-REFERENCE TO RELATED APPLICATIONS

This application claims priority from and the benefit of U.S. Provisional Application No. 63/460,236, entitled “UNINTERRUPTIBLE POWER SUPPLY FOR HVAC&R SYSTEM,” filed Apr. 18, 2023, and U.S. Provisional Application No. 63/443,921, entitled “BEARING SYSTEM FOR HVAC&R SYSTEM,” filed Feb. 7, 2023, each of which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Chiller systems, or vapor compression systems, utilize a working fluid (e.g., a refrigerant) that changes phases between vapor, liquid, and combinations thereof in response to exposure to different temperatures and pressures within components of the chiller system. The chiller system may place the working fluid in a heat exchange relationship with a conditioning fluid (e.g., water) and may deliver the conditioning fluid to conditioning equipment and/or a conditioned environment serviced by the chiller system. In such applications, the conditioning fluid may be directed through downstream equipment, such as air handlers, to condition other fluids, such as air in a building. In the event of a power outage or other interruption in supply of electrical power to the chiller system, certain components of the chiller system may become inoperable.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a heating, ventilation, air conditioning, and/or refrigeration (HVAC&R) system includes a compressor having a bearing. The HVAC&R system also includes a pump configured to supply a flow of pressurized fluid to the bearing. Additionally, the HVAC&R system includes a main power supply configured to supply power to the pump. Furthermore, the HVAC&R system includes an uninterruptible power supply configured to supply power to the pump in response to an interruption in supply of power to the pump via the main power supply.

In another embodiment, a heating, ventilation, air conditioning, and/or refrigeration (HVAC&R) system, includes a compressor having a bearing. The HVAC&R system also includes a pump configured to supply a flow of pressurized fluid to the bearing. Additionally, the HVAC&R system includes a load circuit configured to supply power to the pump. Furthermore, the HVAC&R system includes an electrical enclosure. The electrical enclosure includes a main power supply configured to supply power to the load circuit. Further, the electrical enclosure includes an uninterruptible power supply (UPS) configured to supply power to the load circuit during non-operation of the main power supply.

In another embodiment, a heating, ventilation, air conditioning, and/or refrigeration (HVAC&R) system includes a compressor having a bearing. The compressor is configured to circulate a working fluid through a working fluid circuit. The HVAC&R system further includes a pump configured to supply a flow of pressurized fluid to the bearing. Additionally, the HVAC&R system includes a power supply system. The power supply system includes a main power supply configured to supply power to the pump. Additionally, the power supply system includes an uninterruptible power supply (UPS) configured to supply power to the pump. The power supply system is configured to supply power to the pump via the main power supply in a first configuration and to supply power to the pump via the UPS in a secondary configuration. Additionally, the power supply system is configured to switch from the first configuration to the second configuration in response to an operational interruption of the main power supply.

### DRAWINGS

Various aspects of this disclosure may be better understood upon reading the following detailed description and upon reference to the drawings in which:

FIG. 1 is a perspective view of an embodiment of a building that may utilize a heating, ventilating, air conditioning, and/or refrigeration (HVAC&R) system in a commercial setting, in accordance with an aspect of the present disclosure;

FIG. 2 is a perspective view of an embodiment of a vapor compression system, in accordance with an aspect of the present disclosure;

FIG. 3 is a schematic of an embodiment of a vapor compression system, in accordance with an aspect of the present disclosure;

FIG. 4 is a schematic of an embodiment of a vapor compression system, in accordance with an aspect of the present disclosure;

FIG. 5 is a schematic of an embodiment of a vapor compression system including a bearing system of a compressor, in accordance with an aspect of the present disclosure;

FIG. 6 is a schematic of an embodiment of a power supply system for a bearing system, in accordance with an aspect of the present disclosure;

FIG. 7 is a side view of an embodiment of an electrical enclosure for a vapor compression system, illustrating components disposed within the electrical enclosure, in accordance with an aspect of the present disclosure;

FIG. 8 is a schematic of an embodiment of a power supply system for a pump of a bearing system in a primary configuration, in accordance with an aspect of the present disclosure; and

FIG. 9 is a schematic of an embodiment of a power supply system for a pump of a bearing system in a backup configuration, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” and “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to mean that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to mean that the given feature is within +/-5%, within +/-4%, within +/−3%, within +/−2%, within +/−1%, or even closer, to having the described nature, such as being parallel to another feature, being perpendicular to another feature, and so forth. Further, it should be understood that mathematical terms, such as “planar,” “slope,” “perpendicular,” “parallel,” and so forth are intended to encompass features of surfaces or elements as understood to one of ordinary skill in the relevant art, and should not be rigidly interpreted as might be understood in the mathematical arts. For example, a “planar” surface is intended to encompass a surface that is machined, molded, or otherwise formed to be substantially flat or smooth (within related tolerances) using techniques and tools available to one of ordinary skill in the art. Similarly, a surface having a “slope” is intended to encompass a surface that is machined, molded, or otherwise formed to be oriented at an angle (e.g., incline) with respect to a point of reference using techniques and tools available to one of ordinary skill in the art.

Embodiments of the present disclosure relate to a heating, ventilation, air conditioning, and refrigeration (HVAC&R) system (e.g., a chiller) including a vapor compression system (e.g., vapor compression circuit) having a compressor disposed along a working fluid circuit. In operation, the compressor may pressurize a working fluid within the vapor compression system and direct the working fluid to a condenser (e.g., a first heat exchanger), which may cool and condense the working fluid. The condensed working fluid may be directed to an expansion device, which may reduce a pressure of the working fluid, further cooling the working fluid. From the expansion device, the cooled working fluid may be directed to an evaporator (e.g., a second heat exchanger), where the working fluid may be placed in a heat exchange relationship with a conditioning fluid to cool the conditioning fluid. The conditioning fluid may be circulated between the evaporator and a structure, such as a building, where the conditioning fluid is used to cool an air flow delivered to a conditioned space of the structure. In some embodiments, an air handling unit (AHU) or other equipment of the HVAC&R system may receive the conditioning fluid from the vapor compression system and utilize the conditioning fluid to cool the air flow delivered to the conditioned space. The conditioning fluid may then be returned to the evaporator to be cooled again.

In some embodiments, the compressor may include a bearing system including bearings (e.g., hydrostatic bearings) that utilize a pressurized fluid to support and lubricate a rotating shaft of the compressor. For example, the bearing system may include a lubricant circuit extending from the working fluid circuit and direct a portion of the working fluid from the working fluid circuit into the bearings of the compressor. That is, the portion of the working fluid (e.g., refrigerant) in the lubricant circuit may be utilized as a pressurized fluid (e.g., lubricating fluid). The lubricant circuit may include a pump configured to pressurize the pressurized fluid and/or pump the pressurized fluid toward the bearings of the compressor. In this way, the working fluid, which is configured to exchange heat with the conditioning fluid as part of the working fluid circuit, can also be utilized to lubricate the bearings and enable the bearings to support the shaft of the compressor. An electrical power system may be configured to maintain a continuous supply of power to one or more components of the bearing system (e.g., one or more components of a fluid supply system, the pump) in order to enable continued supply of the pressurized lubricating fluid to the bearings. In this way, support and lubrication of the shaft of the compressor may be sustained (e.g., during operation of the compressor). Unfortunately, supply of power to the bearing system via the electrical power system may be interrupted or otherwise hampered in some instances (e.g., overvoltage, undervoltage, power loss, and so forth). In such circumstances, operation of the pump may be interrupted, which may result in a decrease in the pressure of the pressurized fluid supplied to the bearings. As a result, operation of the compressor may be interrupted or restricted. In particular, the shaft may be inadequately supported and/or inadequately lubricated, which may cause unintended operation, wear, and/or degradation if components of the bearing system, the shaft of the compressor, a motor of the compressor, and/or other components of the vapor compression system. That is, if operation of the pump is interrupted and the pressure of the pressurized fluid is not adequately sustained, the compressor may be vulnerable to wear and degradation caused by uncontrolled momentum, impact forces, and/or friction on the shaft. Therefore, improved and more robust electrical power supply systems for bearing systems of compressors are desired.

Accordingly, present embodiments are directed to a power supply system (e.g., electrical power supply system) configured to at least temporarily enable and facilitate continued operation of a compressor in a vapor compression system in the event of an interruption in normal operation of the power supply system. In particular, power supply systems described herein include a main power supply and an uninterruptible power supply (UPS) configured to supply electrical power to a pump of a bearing system of the vapor compression system in the event of an interruption in supply of power to the pump via the main power supply. In other words, the UPS is configured to provide a backup (e.g., auxiliary, redundant) source of power to the pump if operation of the main power supply is interrupted or otherwise not operating. For example, the power supply system may include a battery configured to store energy and, during non-operation (e.g., an operational interruption) of the main power supply, supply the stored energy to the UPS. The UPS, in turn, uses the energy from the battery to provide backup power to the pump and enable at least temporary continued operation of the pump. The pump may be powered temporarily by the UPS until the main power supply is operable and/or until operation of the compressor is suspended in a controlled manner. In this way, present embodiments enable continued supply of the pressurized lubricating fluid to the bearings via operation of the pump (e.g., and enable a controlled shutdown of the compressor, when appropriate) and enable mitigation of wear and degradation to components of the bearing system and compressor.

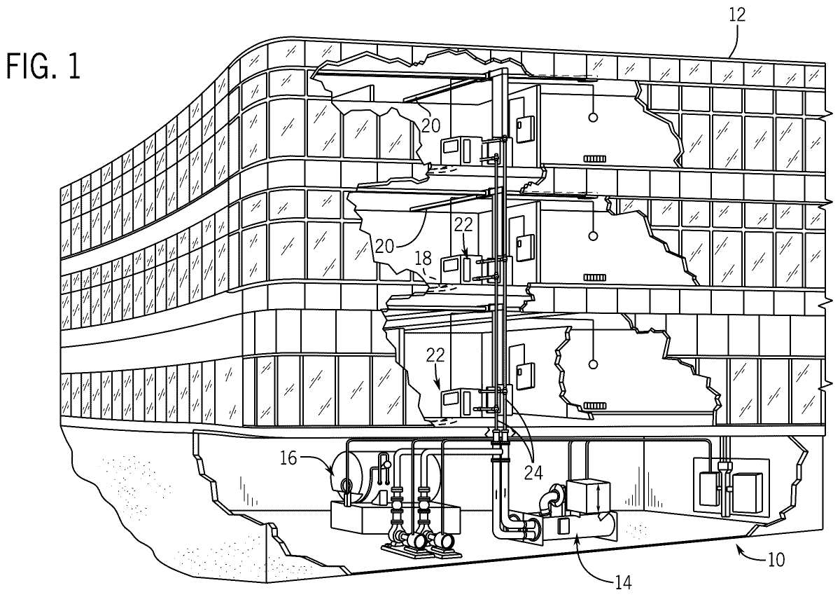

Turning now to the drawings, FIG. 1 is a perspective view of an embodiment of a heating, ventilating, air conditioning, and/or refrigeration (HVAC&R) system 10 in a building 12 for a typical commercial setting. The HVAC&R system may include a vapor compression system 14 to supply chilled liquid to cool the building 12 and a boiler 16 to supply warm liquid to heat the building 12. The vapor compression system 14, also referred to herein as a chiller, may circulate a working fluid (e.g., refrigerant) that is cooled by a cooling fluid (e.g., liquid such as water) in a condenser of the vapor compression system 14, and that is heated by a conditioning fluid (e.g., liquid, such as water) in an evaporator of the vapor compression system 14. The cooling fluid may be provided by a cooling tower which cools the cooling fluid via, for example, ambient air. The conditioning fluid, cooled by the working fluid as noted above, may be utilized to cool an air flow provided to conditioned spaces of the building 12.

The HVAC&R system 10 may also include an air distribution system which circulates air through the building 12. The air distribution system can also include an air return duct 18, an air supply duct 20, and/or an air handler 22. In some embodiments, the air handler 22 may include a heat exchanger that is connected to the boiler 16 and the vapor compression system 14 by conduits 24. The heat exchanger in the air handler 22 may receive either heated liquid from the boiler 16 or the conditioning fluid (e.g., chilled liquid such as water) from the vapor compression system 14, depending on the mode of operation of the HVAC&R system 10. The HVAC&R system 10 is shown with a separate air handler on each floor of building 12, but in other embodiments, the HVAC&R system 10 may include air handlers 22 and/or other components that may be shared between or among floors.

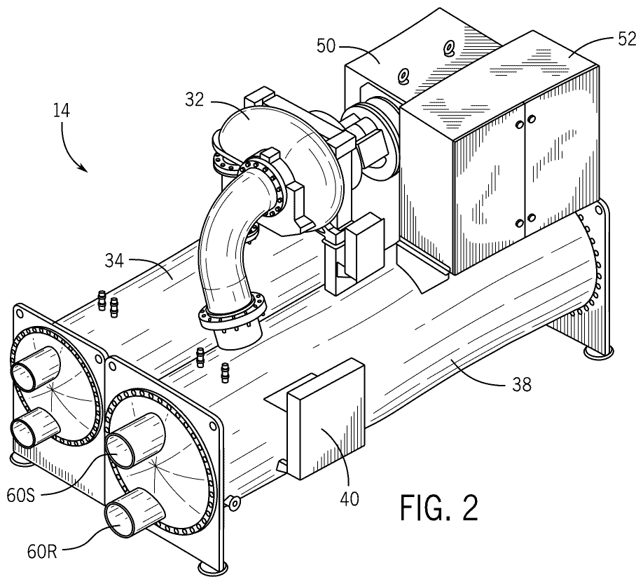

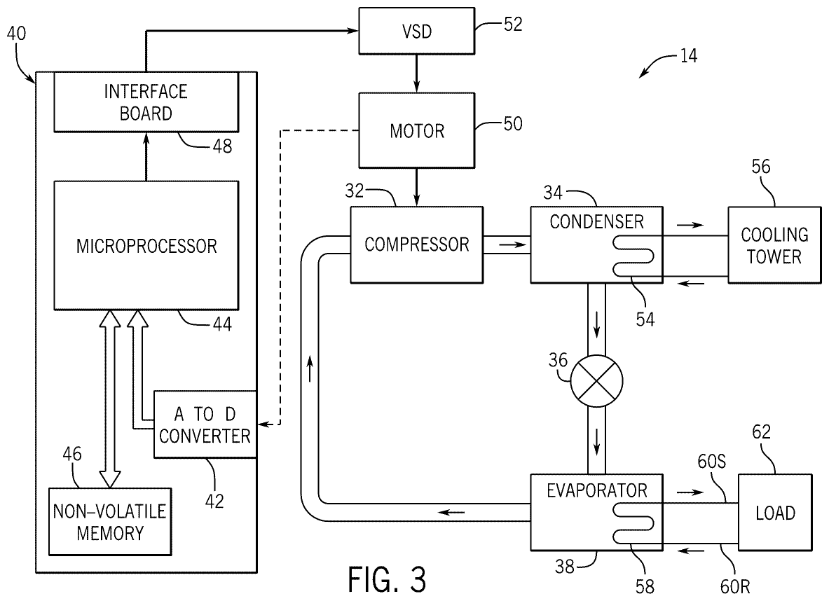

FIGS. 2 and 3 illustrate embodiments of the vapor compression system 14, or chiller, which can be used in the HVAC&R system 10. The vapor compression system 14 may circulate a working fluid through a circuit (e.g., working fluid circuit, refrigerant circuit) starting with a compressor 32, such as a centrifugal compressor. The circuit may also include a condenser 34, an expansion valve(s) or device(s) 36, and an evaporator 38. The vapor compression system 14 may further include a control panel 40 that has an analog to digital (A/D) converter 42, a microprocessor 44, a non-volatile memory 46, and/or an interface board 48.

Some examples of fluids that may be used as working fluids (e.g., refrigerants) in the vapor compression system 14 are hydrofluorocarbon (HFC) based working fluids, for example, R-410A, R-407, R-134a, hydrofluoro olefin (HFO), “natural” working fluids like ammonia (NH₃), R-717, carbon dioxide (CO₂), R-744, or hydrocarbon-based working fluids, water vapor, or any other suitable working fluid. Other possible working fluids include R-123, R-514A, R-1130yd, R-1233zd, R-134a, R-1142ze, R-1142yf, R-1311, R-32, and R-410A. In some embodiments, the vapor compression system 14 may be configured to efficiently utilize working fluids having a normal boiling point of about 19 degrees Celsius (66 degrees Fahrenheit) at one atmosphere of pressure, also referred to as low pressure working fluids, versus a medium pressure working fluid, such as R-134a. As used herein, “normal boiling point” may refer to a boiling point temperature measured at one atmosphere of pressure.

In some embodiments, the vapor compression system 14 may use one or more of a variable speed drive (VSDs) 52, a motor 50, the compressor 32, the condenser 34, the expansion valve or device 36, and/or the evaporator 38. The motor 50 may drive the compressor 32 during a normal operating mode and may be powered by a variable speed drive (VSD) 52. The VSD 52 receives alternating current (AC) power during the normal operating mode, where the AC power includes a particular fixed line voltage and fixed line frequency from an AC power source, and provides power having a variable voltage and frequency to the motor 50. In other embodiments, the motor 50 may be powered directly from an AC or direct current (DC) power source. The motor 50 may include any type of electric motor that can be powered by a VSD or directly from an AC or DC power source, such as a switched reluctance motor, an induction motor, an electronically commutated permanent magnet motor, or another suitable motor.

The compressor 32 compresses a working fluid (e.g., refrigerant) vapor and delivers the vapor to the condenser 34 through a discharge passage. In some embodiments, the compressor 32 may be a centrifugal compressor. The working fluid vapor delivered by the compressor 32 to the condenser 34 may transfer heat to a cooling fluid (e.g., water or air) in the condenser 34. The working fluid vapor may condense to a working fluid liquid in the condenser 34 as a result of thermal heat transfer with the cooling fluid. The liquid working fluid from the condenser 34 may flow through the expansion device 36 to the evaporator 38. In the illustrated embodiment of FIG. 3, the condenser 34 is water cooled and includes a tube bundle 54 connected to a cooling tower 56, which supplies the cooling fluid to the condenser 34.

The liquid working fluid delivered to the evaporator 38 may absorb heat from a conditioning fluid that is subsequently routed to a load 62 (e.g., the building 12 of FIG. 1). For example, the conditioning fluid may be cooled by the working fluid in the evaporator 38, and then may be utilized in the building 12 of FIG. 1 to condition an air flow provided to condition a space in the building 12. The liquid working fluid in the evaporator 38 may undergo a phase change from the liquid working fluid to a working fluid vapor. As shown in the illustrated embodiment of FIG. 3, the evaporator 38 may include a tube bundle 58 having a supply line 60S and a return line 60R connected to the cooling load 62. The conditioning fluid of the evaporator 38 (e.g., water, ethylene glycol, calcium chloride brine, sodium chloride brine, or any other suitable fluid) enters the evaporator 38 via return line 60R and exits the evaporator 38 via supply line 60S. The evaporator 38 may reduce the temperature of the conditioning fluid in the tube bundle 58 via thermal heat transfer with the working fluid. The tube bundle 58 in the evaporator 38 can include a plurality of tubes and/or a plurality of tube bundles. In any case, the vapor working fluid exits the evaporator 38 and returns to the compressor 32 by a suction line to complete the cycle.

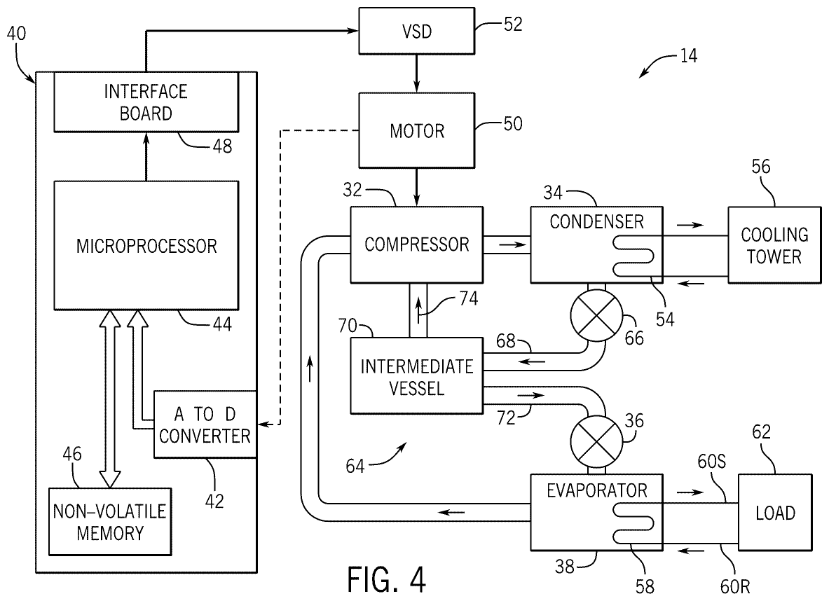

FIG. 4 is a schematic of an embodiment of the vapor compression system 14 with an intermediate circuit 64 incorporated between the condenser 34 and the expansion device 36. The intermediate circuit 64 may have an inlet line 68 that is directly fluidly connected to the condenser 34. In other embodiments, the inlet line 68 may be indirectly fluidly coupled to the condenser 34. As shown in the illustrated embodiment of FIG. 4, the inlet line 68 includes a first expansion device 66 positioned upstream of an intermediate vessel 70. In some embodiments, the intermediate vessel 70 may be a flash tank (e.g., a flash intercooler). In other embodiments, the intermediate vessel 70 may be configured as a heat exchanger or a “surface economizer.” In the illustrated embodiment of FIG. 4, the intermediate vessel 70 is used as a flash tank, and the first expansion device 66 is configured to lower the pressure of (e.g., expand) the liquid working fluid received from the condenser 34. During the expansion process, a portion of the liquid working fluid may vaporize, and thus, the intermediate vessel 70 may be used to separate the vapor working fluid from the liquid refrigerant received from the first expansion device 66.

Additionally, the intermediate vessel 70 may provide for further expansion of the liquid working fluid due to a pressure drop experienced by the liquid working fluid when entering the intermediate vessel 70 (e.g., due to a rapid increase in volume experienced when entering the intermediate vessel 70). The vapor working fluid in the intermediate vessel 70 may be drawn by the compressor 32 through a suction line 74 of the compressor 32. In other embodiments, the vapor working fluid in the intermediate vessel 70 may be drawn to an intermediate stage of the compressor 32 (e.g., not the suction stage). The liquid working fluid that collects in the intermediate vessel 70 may be at a lower enthalpy than the liquid working fluid exiting the condenser 34 due to expansion of the working fluid at the expansion device 66 and/or in the intermediate vessel 70. The liquid working fluid from intermediate vessel 70 may then flow through line 72 and through a second expansion device 36 to the evaporator 38.

In accordance with present embodiments, the compressor 32 may be a centrifugal compressor (e.g., a hermetic compressor) having a levitated rotor or shaft. To this end, the vapor compression system 14 includes a bearing system with one or more bearings configured to support a load of the shaft of the compressor 32. The bearing system is configured to direct a pressurized fluid (e.g., liquid, working fluid, refrigerant) through the bearings, and the bearings are configured to discharge the fluid toward and against the shaft in order to enable levitation of the shaft within the compressor 32. Specifically, the bearings include one or more porous bearing elements configured to receive the pressurized fluid and direct the pressurized fluid toward the shaft within a housing of the compressor 32. In this way, the bearing system may support a load on the shaft and enable rotation of the shaft within the housing of the compressor 32 during operation of the vapor compression system 14. As discussed herein, the pressurized fluid may be a working fluid (e.g., refrigerant) circulated through the vapor compression system 14. Thus, the vapor compression system 14 may not utilize a dedicated lubricant, such as oil, to support and enable rotation of the shaft of the compressor 32. Further, the bearing system may be incorporated with the vapor compression system 14 at reduced costs, as compared to other existing bearing system designs. The disclosed embodiments also enable improved (e.g., simplified) control of the bearing system, as well as more efficient operation of the vapor compression system 14.

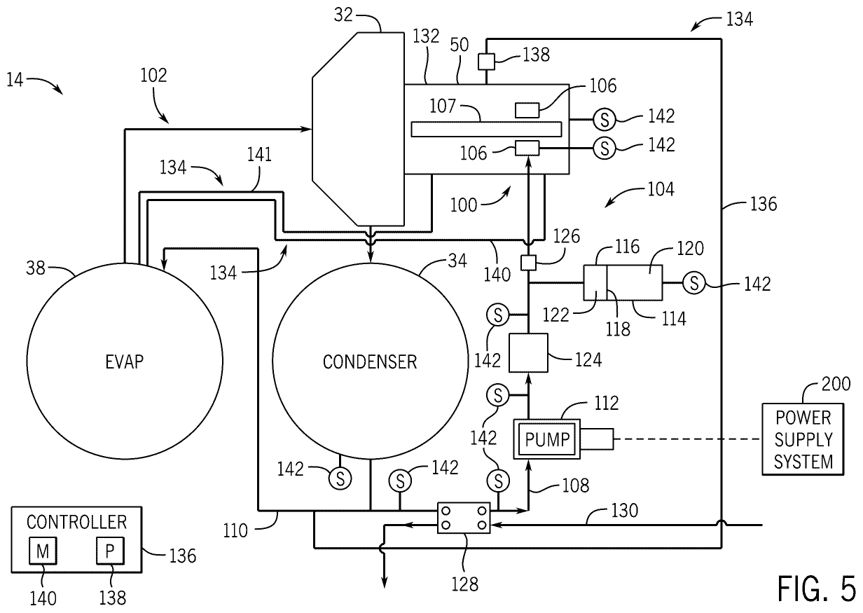

With the foregoing in mind, FIG. 5 is a schematic of an embodiment of the vapor compression system 14 (e.g., HVAC&R system) including a bearing system 100 for the compressor 32. The vapor compression system 14 includes elements similar to those discussed above, including the compressor 32 (e.g., having the motor 50), the condenser 34, and the evaporator 38 (e.g., falling film evaporator) arranged along a working fluid circuit 102 (e.g., refrigerant circuit). In accordance with present techniques, the vapor compression system 14 also includes a fluid supply system 104 configured to direct pressurized fluid to one or more bearings 106 of the bearing system 100 configured to support a load of a shaft 107 of the compressor 32. In particular, the fluid supply system 104 is configured to direct a portion of working fluid circulated through the working fluid circuit 102 to the bearings 106. To this end, the fluid supply system 104 includes a lubricant circuit 108 (e.g., fluid supply circuit) extending from the working fluid circuit 102 to the bearings 106.

In the illustrated embodiment, the lubricant circuit 108 extends from a liquid line portion 110 of the working fluid circuit 102 to the bearings 106. The liquid line portion 110 extends from the condenser 34 to the evaporator 38. Thus, working fluid within the liquid line portion 110 may be in a liquid phase. Various components are disposed along the lubricant circuit 108 and are configured to enable desirable supply of working fluid to the bearings 106 to enable the bearings 106 to support a load of the shaft 107 of the compressor 32. For example, the fluid supply system 104 includes a pump 112 (e.g., liquid pump) disposed along the lubricant circuit 108 and configured to direct flow of working fluid (e.g. liquid refrigerant) along the lubricant circuit 108 from the liquid line portion 110 of the working fluid circuit 102 to the bearings 106 of the motor 50 (e.g., compressor 32). The pump 112 may be a linear piston pump, in some embodiments, and the pump 112 may be driven electrically, pneumatically, mechanically, electromechanically, and/or via another suitable technique. As discussed in greater detail below, a power supply system 200 may provide electric power to operate the pump 112. In some embodiments, the pump 112 may operate without utilizing oil or other dedicated lubricant.

The fluid supply system 104 also includes a pressure accumulator 114 fluidly coupled to the lubricant circuit 108. The pressure accumulator 114 is fluidly coupled to the lubricant circuit 108 downstream of the pump 112 relative to a flow of working fluid along the lubricant circuit 108. Thus, the pressure accumulator 114 may receive a pressurized flow of working fluid (e.g., liquid working fluid, vapor working fluid, or both) from the pump 112 and the lubricant circuit 108. As will be appreciated, the pressure accumulator 114 is configured to store pressurized working fluid therein. For example, the pressure accumulator 114 may include a vessel 116 and a separator 118 (e.g., bladder, diaphragm, piston, etc.) disposed therein. In some embodiments, the separator 118 may divide an internal volume of the vessel 116 into a biasing chamber 120 (e.g., gas chamber) on a first side of the separator 118 and a fluid chamber 122 (e.g., liquid chamber, refrigerant chamber) on a second side the separator 118. The fluid chamber 122 of the pressure accumulator 114 is configured to receive pressurized working fluid from the lubricant circuit 108. The separator 118 may be a bladder or other flexible container pre-charged with a gas (e.g., nitrogen) to enable maintaining the pressure of the working fluid within the fluid chamber 122. In other embodiments, the biasing chamber 120 may be pre-charged with a gas. In still further embodiments, the biasing chamber 120 may instead include a spring or other mechanical biasing component. In any case, the pressure accumulator 114 may operate as a mechanical battery configured to enable supply (e.g., temporary supply) of pressurized working fluid from the fluid chamber 122 to the bearings 106 via the lubricant circuit 108, such as during periods of non-operation of the pump 112. For example, during an interruption in operation of the pump 112, the pressure accumulator 114 may discharge pressurized working fluid to the lubricant circuit 108 for supply to the bearings 106. In this way, the bearings 106 may continue to operate to support a load on the shaft 107 of the compressor 32 while operation of the pump 112 is restarted and/or while operation of the compressor 32 (e.g., the motor 50) is suspended in a controlled manner. In some embodiments, the pressure accumulator 114 may also operate to damp oscillations in the flow of pressurized working fluid directed to the bearings 106. Further, the pressure accumulator 114 may be configured to supply pressurized working fluid to the bearings 106 at startup of the vapor compression system 14 (e.g., prior to operation of the pump 112 and/or the compressor 32).

The fluid supply system 104 may also include other components disposed along the lubricant circuit 108, such as a check valve 124 disposed between the pump 112 and the pressure accumulator 114. The check valve 124 may be configured to close and block flow of liquid working fluid from the pump 112 and along toward the bearings 106 based on a pressure of the liquid working fluid discharged by the pump 112. For example, in response to a pressure of the liquid working fluid falling below a threshold value (e.g., a threshold value corresponding to a liquid working fluid pressure desired for supply to the bearings 106), the check valve 124 may close. In such instances, pressurized liquid working fluid stored within the pressure accumulator 114 may be supplied to the bearings 106 (e.g., with the closed check valve 124 blocking working fluid flow back to the pump 112) to enable at least temporary continued operation of the bearings 106 to support the shaft 107.

In some embodiments, the fluid supply system 104 may include a filter 126 disposed along the lubricant circuit 108 (e.g., downstream of the pressure accumulator 114 and upstream up the bearings 106). The filter 126 (e.g., may be configured to remove particulates and/or moisture (e.g., water, water vapor) from the liquid working fluid prior to the liquid working fluid being directed to the bearings 106.

The fluid supply system 104 may also include a heat exchanger 128 disposed along the lubricant circuit 108. The heat exchanger 128 is disposed upstream of the pump 112 relative to flow of working fluid through the lubricant circuit 108. In some embodiments, the heat exchanger 128 may be a brazed-plate heat exchanger. In operation, the heat exchanger 128 may function as a subcooler configured to subcool working fluid directed from the liquid line portion 110 into the lubricant circuit 108. In this way, the heat exchanger 128 may operate to ensure that the working fluid supplied to the pump 112 is in a liquid phase, which may reduce undesired effects, such as flashing of the working fluid at the pump 112, cavitation of the pump 112, and so forth. The heat exchanger 128 is configured to place the working fluid drawn from the liquid line portion 110 in a heat exchange relationship with a cooling fluid (e.g., auxiliary cooling fluid) directed to the heat exchanger 128 via a cooling fluid circuit 130. The cooling fluid may be water, in some embodiments. In such embodiments, the cooling fluid circuit 130 may be configured to supply the cooling fluid from an external source. Additionally or alternatively, the cooling fluid circuit 130 may be configured to supply water or other cooling fluid (e.g., cooled via the evaporator 38) from a conditioning fluid conduit, such as the supply line 60S and/or the return line 60R described above. In some embodiments, the cooling fluid may be another portion of working fluid from the working fluid circuit 102. In such embodiments, the cooling fluid circuit 130 may extend from the working fluid circuit 102 (e.g., the liquid line portion 110) to the heat exchanger 128. However, it should be appreciated that the cooling fluid circuit 130 may be configured to direct any suitable cooling fluid to the heat exchanger 128 to enable cooling (e.g., subcooling) of the portion of the working fluid directed along the lubricant circuit 108 toward the bearings 106 of the compressor 32.

As mentioned above, the bearings 106 are configured to receive pressurized working fluid and to discharge the working fluid towards the shaft 107 of the compressor 32. In particular, the bearings 106 each include one or more porous elements configured to direct the pressurized working fluid therethrough, to flash the pressurized working fluid, and to discharge pressurized vapor working fluid towards the shaft 107. Thereafter, the working fluid may flow through a housing 132 of the compressor 32 (e.g., motor 50) to one or more drain lines 134 of the bearing system 100. For example, the lubricant circuit 108 may include a first drain line 136 extending from the housing 132 to the liquid line portion 110 of the working fluid circuit 102. The first drain line 136 may include a valve 138 (e.g., electronic expansion valve) and/or may be configured to direct vapor working fluid from the housing 132 to the liquid line portion 110 of the working fluid circuit 102. Additionally or alternatively, the lubricant circuit 108 may include a second drain line 140 extending from the housing 132 to the evaporator 38 and/or a third drain line 141 extending from the housing 132 to the evaporator 38. In some embodiments, the second drain line 140 is configured to direct vapor working fluid from the housing 132 to the evaporator 38, and the third drain line 141 is configured to direct liquid working fluid from the housing 132 to the evaporator 38.

The vapor compression system 14 may also include a controller 136 (e.g., a control system, control board, control panel) communicatively coupled to one or more components of the vapor compression system 14, the fluid supply system 104, and/or the bearing system 100. The controller 136 is configured to monitor, adjust, and/or otherwise control operation of the components of the vapor compression system 14, the fluid supply system 104, and/or the bearing system 100. For example, one or more control transfer devices, such as wires, cables, wireless communication devices, and the like, may communicatively couple the compressor 32, the motor 50, the pump 112, and/or other components described herein. Such components may include a network interface that enables the components of the vapor compression system 14, the fluid supply system 104, and/or bearing system 100 to communicate via various protocols such as EtherNet/IP, ControlNet, DeviceNet, or any other communication network protocol. Alternatively, the communication component may enable the components of the vapor compression system 14, the fluid supply system 104, and/or bearing system 100 to communicate via mobile telecommunications technology, Bluetooth®, near-field communications technology, and the like.

In some embodiments, the controller 136 may include a portion or all of the control panel 40 or may be another suitable controller included in the vapor compression system 14, the fluid supply system 104, and/or the bearing system 100. In any case, the controller 136 may be configured to control components of the vapor compression system 14, the fluid supply system 104, and/or the bearing system 100 in accordance with the techniques discussed herein. The controller 136 includes processing circuitry 138, such as one or more microprocessors, which may execute software for controlling the components of the vapor compression system 14, the fluid supply system 104, and/or the bearing system 100. The processing circuitry 138 may include multiple microprocessors, one or more “general-purpose” microprocessors, one or more special-purpose microprocessors, and/or one or more application specific integrated circuits (ASICS), or some combination thereof. For example, the processing circuitry 138 may include one or more reduced instruction set (RISC) processors.

The controller 136 may also include a memory device 140 (e.g., a memory) that may store information such as instructions, control software, look up tables, configuration data, etc. The memory device 140 may include a volatile memory, such as random access memory (RAM), and/or a nonvolatile memory, such as read-only memory (ROM). The memory device 140 may store a variety of information and may be used for various purposes. For example, the memory device 140 may store processor-executable instructions including firmware or software for the processing circuitry 138 to execute, such as instructions for controlling components of the vapor compression system 14, the fluid supply system 104, and/or the bearing system 100. In some embodiments, the memory device 140 is a tangible, non-transitory, machine-readable-medium that may store machine-readable instructions for the processing circuitry 138 to execute. The memory device 140 may include ROM, flash memory, a hard drive, or any other suitable optical, magnetic, or solid-state storage medium, or a combination thereof. The memory device 140 may store data, instructions, and any other suitable data.

The controller 136 may be configured to control operation of components of the vapor compression system 14, the fluid supply system 104, and/or the bearing system 100 based on detected operating parameters of the vapor compression system 14, the fluid supply system 104, and/or the bearing system 100. To this end, the vapor compression system 14 includes one or more sensors 142 configured to detect operating parameters associated with or indicative of operating conditions of the vapor compression system 14 and the bearing system 100. For example, one or more of the sensors 142 may be disposed along the lubricant circuit 108 and may be configured to detect operating parameters of the working fluid directed through the lubricant circuit 108, such as temperature, pressure, flow rate, and so forth. In some embodiments, one or more sensors 142 may be configured to detect an operating parameter associated with the motor 50, such as a rotational speed of the shaft 107, a torque on the shaft 107, a temperature of the motor 50, and so forth. One or more sensors 142 may be configured to detect an operating parameter of the bearings 106, such as a detection of whether one or more bearings 106 is in contact (e.g., physical contact) with the shaft 107, as described further below.

In some embodiments, one of the sensors 142 may be configured to detect an operating parameter associated with the pressure accumulator 114, such as a pressure of refrigerant within the fluid chamber 122 and/or a pressure of gas within the biasing chamber 120. Additionally or alternatively, one or more of the sensors 142 may be configured to detect a liquid level of working fluid within the condenser 34, which may be referenced before and/or during startup of the bearing system 100, the fluid supply system 104, and/or vapor compression system 14. As will be appreciated, each sensor 142 included in the vapor compression system 14 may be communicatively coupled to the controller 136. Thus, the controller 136 may receive data and/or feedback from the sensors 142 and may control operation of the vapor compression system 14 and/or the bearing system 100 based on the feedback and/or data.

The controller 136 may also be communicatively coupled to the power supply system 200, and the controller 136 may be configured to adjust operation of one or more components of the vapor compression system 14 (e.g., compressor 32, bearing system 100) based on data, feedback, and/or other signals received from the power supply system 200. For example, in response to an indication that operation of a main power supply (e.g., primary power supply) of the power supply system 200 is interrupted and operation of a UPS of the power supply system 200 is initiated, the controller 136 may adjust operation of the compressor 32 and/or bearing system 100. In some instances, the controller 136 may initiate a controlled shutdown of the compressor 32 (e.g., the motor 50) based on data received from the power supply system 200.

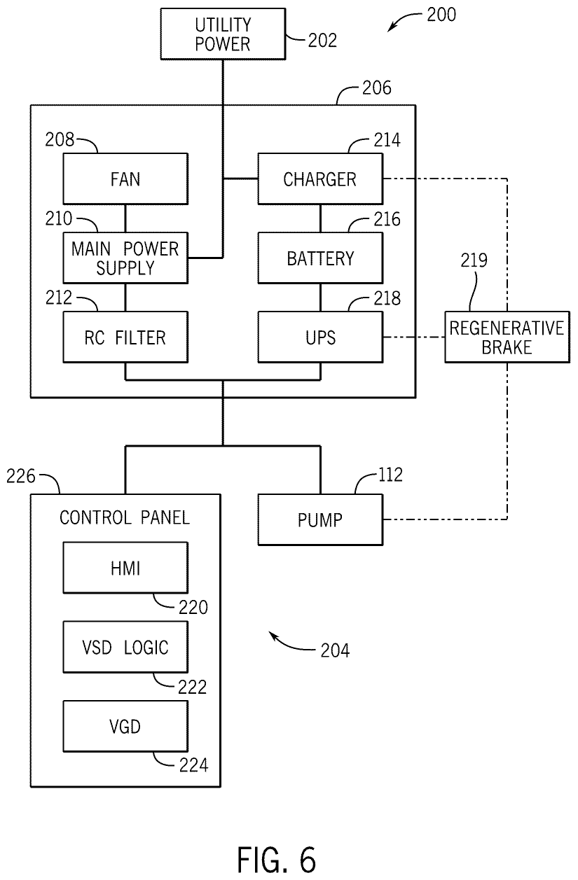

FIG. 6 is a schematic of an embodiment of the power supply system 200 configured to supply electrical power to one or more components of the vapor compression system 14. For example, the power supply system 200 may supply electrical power to components of the bearing system 100 and/or the fluid supply system 104, such as the pump 112. The power supply system 200 may receive power from a utility power source 202 (e.g., an electric grid, a generator, solar panels, and so forth), transform the power into a desired form (e.g., suitable voltage), and supply the power to one or more components of the vapor compression system 14, which may be electrically coupled to a load circuit 204 of the vapor compression system 14. In particular, the load circuit 204 may be configured to supply the power to the pump 112. In some instances, the load circuit 204 may be considered a priority load circuit configured to enable supply of power to a subset of components of the vapor compression system 14 to enable continued operation of such components and avoid unintended operation, wear, and/or degradation of the vapor compression system 14 (e.g., the compressor 32). The power supply system 200 may include an electrical enclosure 206 configured to house a fan 208, a main power supply 210 (e.g., primary power supply), a resistor-capacitor (RC) filter 212, a charger 214, a battery 216, and an uninterruptible power supply (UPS) 218 (e.g., backup power supply).

During a normal operating state of the main power supply 210, the main power supply 210 draws alternating current (AC) current having a particular fixed line voltage (e.g., 120 V) and fixed line frequency (e.g., 60 Hz) from the utility power source 202. The main power supply 210 is configured to convert the AC current from the utility power source 202 to a suitable voltage, current, and frequency that may be utilized to power components, such as the pump 112, via the load circuit 204. For example, the main power supply 210 may include transformers, filter capacitors, rectifiers, inverters, and/or control logic to convert the AC current into a usable form for the load circuit 204. In some embodiments, the main power supply 210 may generate a DC output voltage. The RC filter 212 may be a low-pass filter configured to condition the output voltage from the main power supply 210 and/or the UPS 218. That is, the RC filter 212 may reduce or mitigate noise in the voltage and/or smooth the current being supplied to the load circuit 204. In addition to supplying power to the load circuit 204, the main power supply 210 may power the fan 208 to cool the electrical enclosure 206. In some embodiments, the electrical enclosure 206 may be liquid cooled by circulating a cooling fluid (e.g., a refrigerant) through a heat exchanger disposed within the electrical enclosure 206.

The UPS 218 is configured to enable supply of electrical power (e.g., backup power) as an alternative to the main power supply 210. For example, if operation of the main power supply 210 is interrupted (e.g., due to loss of power from the utility power source 202), the UPS 218 may provide backup power to the load circuit 204 temporarily, thereby enabling continued operation of the pump 112 and other components electrically coupled to the load circuit 204 (e.g., during operational interruption of the main power supply 210). In particular, the UPS 218 enables continued operation of the pump 112 for a time period during which the compressor 32 may be controlled to shutdown in a desired manner. That is, the pump 112, being powered by the UPS 218, may continue to operate to pressurize the working fluid and/or pump the working fluid (e.g., lubricating fluid) through the bearings 106 via the lubricant circuit 108. To this end, the UPS 218 may be powered by a battery 216 (e.g., a lead-acid battery, a lithium battery, an alkaline battery, etc.). The battery 216 is configured to store electrical energy and supply power to the UPS 218 during instances in which supply of power via the main power supply 210 is unavailable (e.g., during an interruption in power received from the utility power source 202). The UPS 218 may include transformers, filter capacitors, rectifiers, inverters, and/or control logic to convert current from the battery 216 into a desired voltage, current, and/or frequency to be used by the load circuit 204 and components connected to the load circuit 204. For example, the UPS 218 may include a DC-to-DC converter to generate an output voltage greater or less than the voltage of the battery 216. In some embodiments, the power supply system 200 may include the charger 214. The charger 214 may receive AC current from the utility power source 202 and convert the AC current into DC power (e.g., via an AC-to-DC converter) to charge the battery 216 (e.g., store the DC power in the battery 216). In other embodiments, the charger 214 may receive power from the main power supply 210, or the battery 216 may be charged directly by the main power supply 210 without the charger 214 electrically coupled therebetween.

In other embodiments, power supplied to the load circuit 204 may be generated by harnessing a counter-electromotive force (back EMF) from the motor 50 to power the pump 112. For example, the power supply system 200 may include a regenerative brake 219 operatively (e.g., electrically) coupled to the UPS 218, the charger 214, and/or the pump 112. The regenerative brake 219 be configured to convert kinetic energy of the rotating shaft 107 of the motor 50 and/or compressor 32 into electrical energy to power the pump 112. Additionally or alternatively, the pump 112 may be powered directly by a regenerative braking mechanism (e.g., regenerative brake 219) of the motor 50 without the UPS 218. For example, the regenerative brake 219 may be coupled to the motor 50 to generate a back EMF to power the pump 112 in response to detection of an operational interruption of the main power supply 210. In some instances, operation of the main power supply 210 may be interrupted while the shaft 107 of the motor is rotating. By harnessing the kinetic energy of the shaft 107, the regenerative brake 219 may produce the electrical energy to provide power to the load circuit 204 while the main power supply 210 is not operating. In this way, operation of the load circuit 204 may be sustained until the main power supply 210 is operable or until components of the HVAC&R system 14 (e.g., compressor 32) can be brought to a controlled stop.

The load circuit 204 may include and/or be configured to supply power to a number of electrical and electromechanical components that facilitate desirable operation of one or more components of the HVAC&R system 10, such as during instances of power supply interruption via the main power supply 210 and/or the utility power source 202. In the illustrated embodiment, the load circuit 204 includes (e.g., is electrically coupled to) a computing device having a human-machine interface (HMI) 220 (e.g., user interface), control logic (e.g., control circuitry) for a variable speed drive (VSD) 222, and an actuator for a variable geometry diffuser (VGD) 224. The HMI 220, the VSD logic 222, and the VGD actuator 224 may be configured as part of a control panel 226 configured to receive power from the main power supply 210 and/or the UPS 218. In other embodiments, the load circuit 204 may include and/or be electrically coupled to other electrical or electromechanical components, such as the valve 138, the sensors 142, the controller 136, and/or an additional pump configured to pump the cooling fluid 130 through the heat exchanger 128. As discussed above, the main power supply 210 may supply power to these components via the load circuit 204 in a normal operating state of the power supply system 200. In case of an interruption to the operation of the main power supply 210, the UPS 218 may supply power to these components via the load circuit 204.

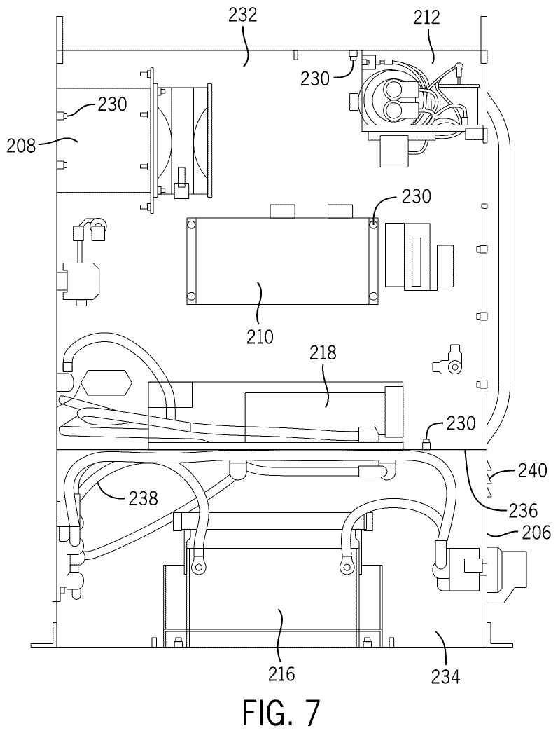

FIG. 7 is a side view of an embodiment of the electrical enclosure 206 and components disposed therein. The fan 208, the main power supply 210, the RC filter 212, the battery 216, and the UPS 218 may be coupled to the electrical enclosure 206 (e.g., walls of the electrical enclosure 206) via fasteners 230. In the illustrated embodiment, a first compartment 232 (e.g., first section, first portion) of the electrical enclosure 206 houses the fan 208, the main power supply 210, the RC filter 212, and the UPS 218, and a second compartment 234 of the electrical enclosure 206 houses the battery 216. The first compartment 232 and the second compartment 234 may be divided by a partition 236. Wires 238 may electrically couple the UPS 218 and the battery 216 and may extend through the partition 236. The electrical enclosure 206 may further include openings 240 (e.g., slats, louvers, vents) to facilitate air flow through the electrical enclosure 206 (e.g., to cool the components disposed therein). The fan 208 may draw air through the openings 240 to cool the components inside the electrical enclosure 206.

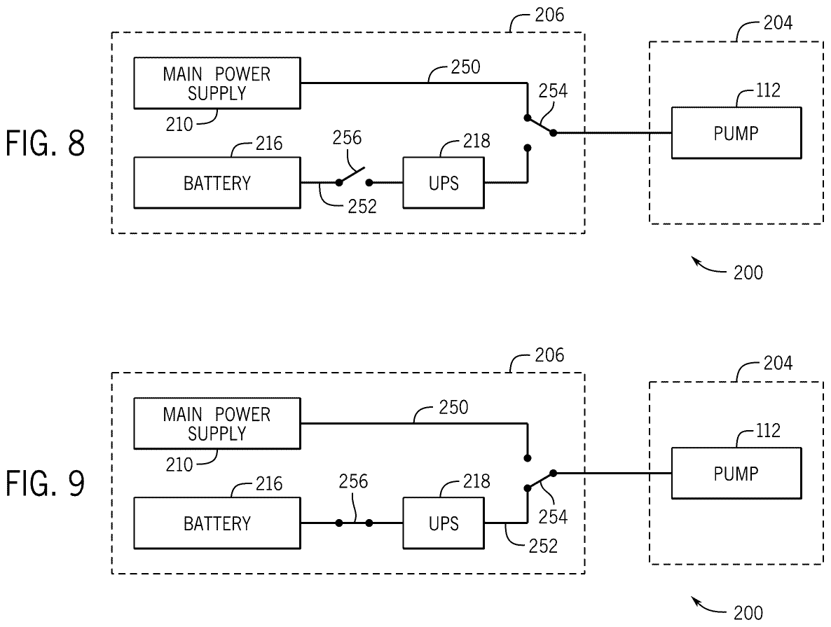

FIG. 8 is a schematic of an embodiment of the power supply system 200, illustrating operation of the power supply system 200 in a primary configuration (e.g., first configuration) of the power supply system. For example, during a normal operating state of the main power supply 210 (e.g., when the main power supply 210 is operable and receiving power from the utility power source 202), the primary configuration may enable the main power supply 210 to supply power to the load circuit 202 (e.g., pump 112). In the primary configuration, the main power supply 210 generates an output voltage and directs current to the pump 112 via a first electrical path 250. The pump 112, powered by the output voltage provided by the main power supply 210, pumps a flow of working fluid (e.g., refrigerant) along the lubricant circuit 108 to the bearings 106, which enables levitation and lubrication of the shaft 107 of the compressor 32, as discussed above. In the primary configuration, the UPS 218 may not supply power to the pump 112. For example, the battery 216 and the UPS 218 may be disposed along a second electrical path 252. A switch 254 (e.g., a single pole double throw switch) may connect the pump 112 to the first electrical path 250 and disconnect the pump 112 from the second electrical path 252 in the primary power configuration. Indeed, in the primary configuration, the switch may be configured to close the first electrical path 360 and open the second electrical path 252. An additional switch 256 disposed along the second electrical path 252 may disconnect the UPS 218 from the battery 216. In this way, no current may flow through the second electrical path 252 (e.g., from the battery 216 to the UPS 218, from the UPS 218 to the pump 112) during the normal operating state of the main power supply 210.

FIG. 9 is a schematic of an embodiment of the power supply system 200, illustrating operation of the power supply system 200 in a backup configuration (e.g., second configuration) of the power supply system 200. For example, in some circumstances, the utility power source 202 may not supply power to the power supply system 200, such as during a power outage (e.g., suspended supply of power via the utility power source 202). In other instances, operation of the main power supply 210 may be interrupted for other reasons. In such situations, the UPS 218, the pump 112, the main power supply 210, the controller 136, one or more of the sensors 142 (e.g., voltage sensor, current sensor), control circuitry, and/or sensing circuitry may detect a state of non-operation (e.g., an operational interruption) of the main power supply 210, such as a fault or a power outage (e.g., of the utility power source 202). In response to the detection, the aforementioned circuitry may activate the supply of backup power via the UPS 218 by toggling (e.g., throwing) the switch 254 to establish a connection between the UPS 218 and the load circuit 202 (e.g., pump 112). Indeed, during a non-operating state of the main power supply 210, the switch 254 may open the first electrical path 250 and close the second electrical path 252. Additionally, in the backup configuration, the additional switch 256 may be closed to establish a connection between the UPS 218 and the battery 216. In this way, the battery 216 may supply power to the UPS 218, and the UPS 218 may supply current to the load circuit 202 (e.g., pump 112) via the second electrical path 252.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A heating, ventilation, air conditioning, and/or refrigeration (HVAC&R) system, comprising:
a compressor comprising a bearing;
a pump configured to supply a flow of pressurized fluid to the bearing;
a main power supply configured to supply power to the pump; and
an uninterruptible power supply configured to supply power to the pump in response to an interruption in supply of power to the pump via the main power supply.

2. The HVAC&R system of claim 1, comprising a battery configured to supply power to the uninterruptible power supply.

3. The HVAC&R system of claim 2, comprising a battery charger configured to:
receive alternating current from a utility power source;
convert the alternating current to direct current; and
supply the direct current to the battery.

4. The HVAC&R system of claim 1, wherein:
the main power supply is configured to supply power to a control panel, a human-machine interface, a logic board of a variable speed drive, an actuator of a variable geometry diffuser, or a combination thereof; and
the uninterruptible power supply is configured to supply power to the control panel, the human-machine interface, the logic board of the variable speed drive, the actuator of the variable geometry diffuser, or the combination thereof in response to the interruption in supply of power to the pump via the main power supply.

5. The HVAC&R system of claim 1, comprising:
a motor shaft disposed within the compressor; and
a regenerative brake configured to convert kinetic energy of the motor shaft into electrical energy and to supply the electrical energy to the pump.

6. The HVAC&R system of claim 1, comprising control circuitry configured to:
detect the interruption in supply of power to the pump via the main power supply; and
toggle a switch to establish an electrical connection between the uninterruptible power supply and the pump in response to detection of the interruption.

7. The HVAC&R system of claim 1, wherein the compressor is configured to circulate a working fluid through a working fluid circuit of the HVAC&R system, and the pump is configured to supply a portion of the working fluid to the bearing as the flow of pressurized fluid.

8. The HVAC&R system of claim 1, wherein the pressurized fluid comprises a refrigerant.

9. A heating, ventilation, air conditioning, and/or refrigeration (HVAC&R) system, comprising:
a compressor comprising a bearing;
a pump configured to supply a flow of pressurized fluid to the bearing;
a load circuit configured to supply power to the pump; and
an electrical enclosure, comprising:
a main power supply configured to supply power to the load circuit; and
an uninterruptible power supply (UPS) configured to supply power to the load circuit during non-operation of the main power supply.

10. The HVAC&R system of claim 9, wherein the electrical enclosure comprises:
a fan configured to provide cooling within the electrical enclosure;
a resistor-capacitor (RC) filter configured to condition power supplied via the main power supply, the UPS, or both;
a battery configured to supply power to the UPS;
a battery charger configured to charge the battery; or
a combination thereof.

11. The HVAC&R system of claim 9, wherein the load circuit is configured to supply power to a control panel of the HVAC&R system, a human-machine interface, a logic board of a variable speed drive of the HVAC&R system, an actuator of a variable geometry diffuser of the HVAC&R system, or a combination thereof.

12. The HVAC&R system of claim 9, comprising a regenerative brake configured to generate power during the non-operation of the main power supply and to supply power to the load circuit.

13. The HVAC&R system of claim 9, comprising control circuitry configured to:
detect non-operation of the main power supply; and
toggle a switch to establish an electrical connection between the UPS and the load circuit in response to detection of non-operation of the main power supply.

14. The HVAC&R system of claim 13, comprising:
a first electrical path configured to electrically connect the main power supply and the load circuit; and
a second electrical path configured to electrically connect the UPS and the load circuit,
wherein the switch is configured to close the first electrical path during operation of the main power supply.

15. The HVAC&R system of claim 9, wherein the compressor is configured to circulate a working fluid through a working fluid circuit of the HVAC&R system, and the flow of the pressurized fluid comprises a portion of the working fluid.

16. A heating, ventilation, air conditioning, and/or refrigeration (HVAC&R) system, comprising:
a compressor comprising a bearing, wherein the compressor is configured to circulate a working fluid through a working fluid circuit;
a pump configured to supply a flow of pressurized fluid to the bearing; and
a power supply system, comprising:
a main power supply configured to supply power to the pump; and
an uninterruptible power supply (UPS) configured to supply power to the pump,
wherein the power supply system is configured to supply power to the pump via the main power supply in a first configuration and to supply power to the pump via the UPS in a secondary configuration, wherein the power supply system is configured to switch from the first configuration to the second configuration in response to an operational interruption of the main power supply.

17. The HVAC&R system of claim 16, wherein pump is configured to direct the flow of pressurized fluid from the working fluid circuit to the bearing, the flow of pressurized fluid comprises a portion of the working fluid.

18. The HVAC&R system of claim 16, wherein the power supply system is configured to toggle a switch of the power supply system to transition the power supply system from the first configuration to the second configuration in response to the operational interruption of the main power supply.

19. The HVAC&R system of claim 16, comprising a switch configured to:
electrically connect the main power supply and the pump in the first configuration,
electrically disconnect the UPS and the pump in the first configuration,
electrically connect the UPS and the pump in the second configuration, and
electrically disconnect the main power supply and the pump in the second configuration.

20. The HVAC&R system of claim 16, wherein the power supply system comprises a battery configured to provide power to the UPS, and the main power supply is configured to charge the battery in the first configuration.
